(19) United States
(12) Patent Application Publication
(10) Pub. No.: US 2023/0182536 A1
(43) Pub. Date: Jun. 15, 2023

(54) HIGH VOLTAGE HEATER WITH WELDED TUBES

(71) Applicant: MAHLE International GmbH, Stuttgart (DE)

(72) Inventors: Christian Buerck, Rutesheim (DE); Andreas Koenig, Muehlacker (DE); Jens Richter, Grossbottwar (DE)

(21) Appl. No.: 18/081,639

(22) Filed: Dec. 14, 2022

(30) Foreign Application Priority Data
Dec. 15, 2021 (DE) 10 2021 214 435.7

(51) Int. Cl. B60H 1/22; F24H 1/10; H05B 3/28

(52) U.S. Cl. CPC B60H 1/2221; F24H 1/102; H05B 3/28; H05B 2203/02; H05B 2203/013

(57) ABSTRACT

A high-voltage heater for a motor vehicle for heating a coolant is disclosed. The high-voltage heater includes at least two flat tubes that are flowable through by the coolant and at least one heating element. The at leas two flat tubes and the at least one heating element are alternatingly stacked on top of one another in a stacking direction to form a stack. The at least one heating element is connected at least to one of the adjacent flat tubes in the stack in a heat-transferring manner.

### CROSS-REFERENCE TO RELATED APPLICATION

This application claims priority to German Application No. DE 10 2021 214 435.7 filed on Dec. 15, 2021 the contents of which are hereby incorporated by reference in its entirety.

### TECHNICAL FIELD

The invention relates to a high-voltage heater for a motor vehicle for heating a coolant.

### BACKGROUND

High-voltage heaters are already known from the prior art. Usually, the high-voltage heaters include a tube that can be flowed through by the fluid and a heating element for heating the fluid. The construction of the high-voltage heater can differ.

From DE 10 2017 129 749 A1 it is known for example to arrange the heating element on the outside of the tube in a heat-transferring manner.

From EP 3 273 177 A1 it is known to arrange the heating element in the tube so that it can be flowed about by the fluid.

From DE 10 2018 215 398 A1 a high-voltage heater having multiple stacked discs soldered to one another and with heating elements arranged in between is also known. However, the soldering of the stacked disc in this case and the arranging of the heating elements between the stacked discs is complicated.

The object of the invention therefore is to state for a high-voltage heater of the generic type an improved or at least alternative embodiment, in which the described disadvantages are overcome.

According to the invention, this object is solved through the subject of the independent claim(s). Advantageous embodiments are subject of the dependent claims.

### SUMMARY

The present invention is based on the general idea of replacing in a high-voltage heater stacked discs soldered to one another with flat tubes and to connect the flat tubes to a heating element in a heat-transferring manner.

The high-voltage heater according to the invention is provided for heating a coolant for a motor vehicle. The high-voltage heater comprises at least two flat tubes that can be flowed through by the coolant and at least one heating element. The flat tubes and the heating element are stacked on top of one another and alternatingly in a stacking direction to form a stack. The respective heating element is connected to at least one of the adjacent flat tubes in a heat-transferring manner.

The heating element can be crimped to the respective flat tube in a heat-transferring manner or glued to the respective flat tube in a heat-transferring manner by means of a heat-conductive adhesive. Because of this, the heat exchange between the heating element and the coolant can take place in the flat tube. The respective flat tube can be an extruded profile or a welded tube. In addition, the respective flat tube can comprise rips and/or structures on the inside for guiding the coolant through the flat tube. Because of this, the heat exchange between the heating element and the coolant in the flat tube can be intensified in particular.

The high-voltage heater according to the invention is advantageously of a simplified and modular construction. In particular, the number and/or the size of the flat tubes and of the heating elements in the high-voltage heater can be adapted to the desired heating capacity of the high-voltage heater.

In an advantageous embodiment of the high-voltage heater it can be provided that the high-voltage heater comprises two bottoms that are oriented transversely to the stacking direction and opposite and two lids that are oriented transversely to the stacking direction and opposite. Here, the respective lid is connected to the respective bottom in a fluid-tight manner and because of this a box is delimited towards the outside. By way of the two lids and the two bottoms, two boxes that are opposite and are fluid-tight towards the outside are formed. The flat tubes fluidically lead through the respective bottoms into the respective box and thereby fluidically connect the two boxes with one another. The respective box formed by the respective bottom and the respective lid can comprise a coolant inlet and/or a coolant outlet. By way of the coolant inlet, the coolant can be introduced into the respective box and further into the flat tubes and the coolant, by way of the coolant outlet, can then be conducted out of the flat tubes and out of the respective box. The bottoms and the flat tubes can be integrally connected to one another, preferentially welded or laser-welded or soldered or glued. The lids and the bottoms can also be integrally connected to one another, preferentially welded or laser-welded or soldered or glued. Alternatively, the lids and the bottoms can be firmly connected to one another in a positive locking or non-positive locking manner. In order to seal the junction between the respective lid and the respective bottom, a seal can be arranged between the respective lid and the respective bottom and clamped in a sealing manner.

Advantageously it can be provided that the respective flat tubes each comprise two end regions on the longitudinal end side and each a middle region located between the end regions. At least one of the flat tubes comprises an offset at least in one of the end regions. By way of the offset, a distance of the offset flat tubes and at least one of the flat tubes adjacent in the stacking direction can be greater in the end regions than in the middle regions. When the end regions of the flat tubes on the longitudinal end side are connected to the associated bottoms, sufficient bottom material for connecting the two flat tubes to the respective bottom and for cassetting the two flat tubes can be provided by the offset of the flat tubes. A distance of the offset flat tube and the adjacent flat tube in the middle regions can be additionally selected irrespective of the distance in the end regions. Accordingly, the thickness of the heating element arranged between the two flat tubes can be any. Basically, the distance of the adjacent flat tubes can be between 0.2 mm and 6 mm. The distance of the offset flat tube and of the adjacent flat tube can be greater in particular than 2 mm in the end regions.

Advantageously, the high-voltage heater can comprise a housing arranged round about the stack. The housing can be arranged transversely to the stacking direction between two bottoms of the high-voltage heater and each be connected to the bottoms in a fluid-tight manner by means of an elastic ring seal or by means of a bonding. In other words, the housing can be open facing the bottoms on the longitudinal end side and closed with the bottoms on the longitudinal end side. The housing surrounds the stack consisting of the flat tubes and the heating elements towards the outside and protecting the same. The housing can be formed in particular out of aluminium for improving the EMC (Electromagnetic Compatibility). Alternatively, the housing can be formed out of plastic by an injection moulding method.

In an advantageous embodiment, the high-voltage heater can comprise a circuit board with at least one semi-conductor element, wherein the circuit board is contacted with the respective semi-conductor element in an electrically conductive manner. The respective semi-conductor element can be connected to the flat tube—in particular to the flat tube located in the stack on the outside—in a heat-transferring manner and thus cooled. The semi-conductor element can be crimped to the flat tube in a heat-transferring manner by means of a holding frame or glued to the flat tube in a heat-transferring manner by means of a heat-conductive adhesive. The semi-conductor element can be for example a bipolar transistor with insulated gate electrode or IGBT (IGBT: Insulated Gate Bipolar Transistor). In addition, the circuit board can be contacted with the respective heating element via a flexible or stiff current conductor rail in an electrically conductive manner. Further, the high-voltage heater can comprise a connector and the circuit board can be electrically conductible towards the outside via the connector. The circuit board can be stiff or flexible. The flexible circuit board is a so-called FPC (FPC: Flexible Printed Circuit) and the stiff circuit board is a so-called PCB (PCB: Printed Circuit Board).

In addition, the high-voltage heater can comprise a holding frame which carries the at least one semi-conductor element and the circuit board. The circuit board can be screwed to the holding frame. The holding frame itself is firmly connected to a housing of the high-voltage heater and/or to the stack of the high-voltage heater. Thus, the holding frame can be glued and/or screwed to the housing and/or to the stack. In addition, the holding frame can press the at least one semi-conductor element against the flat tube—in particular against the flat tube located in the stack on the outside, so that between the semi-conductor element and the flat tube a heat-transferring contact is established. In addition, legs of the at least one semi-conductor element can be guided in the holding frame so that a cassetting of the circuit board is simplified.

In an advantageous embodiment of the high-voltage heater, the respective heating element can be a PTC heating element. The PTC heating element comprises at least one PTC stone, two electrically conductive contact plates and two dielectric insulating plates. The at least one PTC stone is practically arranged between the contact plates and connected to these in an electrically conductive manner. The insulating plates are arranged on the contact plates facing away from the at least one PTC stone. The PTC heating element is then connected to at least one of the flat tubes in a heat-transferring manner. Here, the PTC heating element can be for example glued to the flat tube in a heat-transferring manner for example by means of a heat-conductive adhesive. The PTC heating element lies against the flat tube with the insulating plate and is thus electrically insulated from the flat tube.

In a further embodiment of the high-voltage heater, the respective heating element can be a TFR heating element (TFR: Thick Film Resistor). The TFR heating element comprises a substrate, a first dielectric insulation layer, a resistance track and a second dielectric insulation layer. The respective insulation layer can be single-layer or multi-layer. The substrate of the TFR heating element can be realised in particular by the at least one flat tube of the high-voltage heater. Here, the first insulation layer is applied to the substrate, the resistance track to the first insulation layer and the second insulation layer to the resistance track. In other words, the resistance track is arranged between the two insulation layers. The application can take place by a thick film technology, for example by screen printing.

In a further embodiment of the high-voltage heater, the respective heating element can be a film element. The film heating element comprises a first dielectric insulation film, a resistance track and a second dielectric insulation film. The resistance track is arranged between the first insulation layer and the second insulation layer. The film heating element can be integrally connected to the at least one flat tube of the high-voltage heater. In particular, the film heating element can be glued to the at least one flat tube in a heat-transferring manner by means of a heat-conductive adhesive.

Further important features and advantages of the invention are obtained from the subclaims, from the drawings and from the associated figure description by way of the drawings.

It is to be understood that the features mentioned above and still to be explained in the following can not only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically:

FIGS. 1 and 2 a view and an exploded view of a high-voltage heater according to the invention;

FIGS. 3 and 4 a view and an exploded view of a stack in the high-voltage heater according to the invention;

FIG. 5 a view of a heating element in the stack according to FIG. 3 and FIG. 4 in the form of a TFR heating element;

FIG. 6 a view of a flat tube with the printed-on TFR heating element according to FIG. 5;

FIGS. 7 and 8 a plan view and a lateral view of the heating element in the stack according to FIG. 3 and FIG. 4 in the form of a PTC heating element;

FIG. 9 a plan view of a heating element in the stack according to FIG. 3 and FIG. 4 in the form of a film heating element;

FIGS. 10 to 13 views of the high-voltage heater according to the invention each in a partly constructed state.

### DETAILED DESCRIPTION

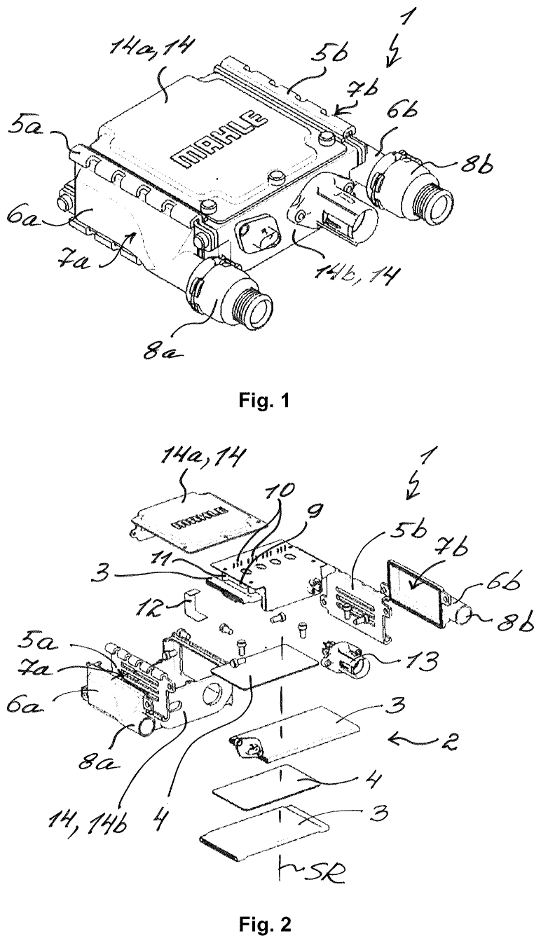

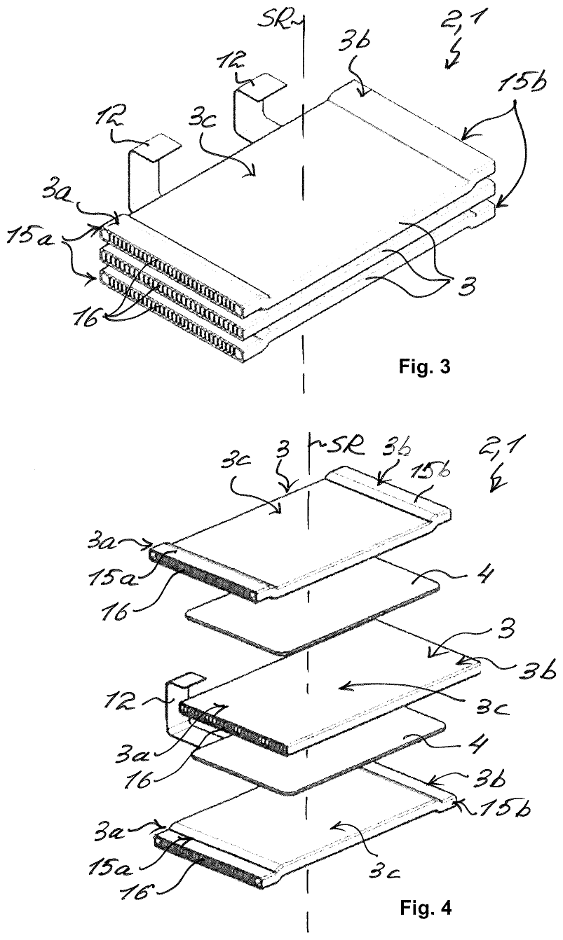

FIG. 1 shows a view of a high-voltage heater 1 according to the invention. In FIG. 2, an exploded view of the high-voltage heater 1 is shown. The high-voltage heater 1 includes a stack 2 having multiple—here three—flat tubes 3 and having multiple—here two—heating elements 4. The flat tubes 3 and the heating elements 4 are alternatingly stacked in a stacking direction SR, wherein the heating elements 4 lie against the respective adjacent flat tubes 3 in a heat-transferring manner. The construction of the stack 2 is explained in more detail in the following by way of FIGS. 3 and 4.

Further, the high-voltage heater 1 comprises two bottoms 5a and 5b and two lids 6a and 6b. The bottoms 5a and 5b are connected to the lids 6a and 6b in a fluid-tight manner, so that boxes 7a and 7b are formed. In the box 7a, a coolant inlet 8a and in the box 7b a coolant outlet 8b are formed. Here, the flat tubes 3 fluidically lead on the one hand into the bottom 5a and thus into the box 7a and on the other hand into the bottom 5b and thus into the box 7b. The flat tubes 3 are connected integrally and in a fluid-tight manner to the respective bottoms 5a and 5b.

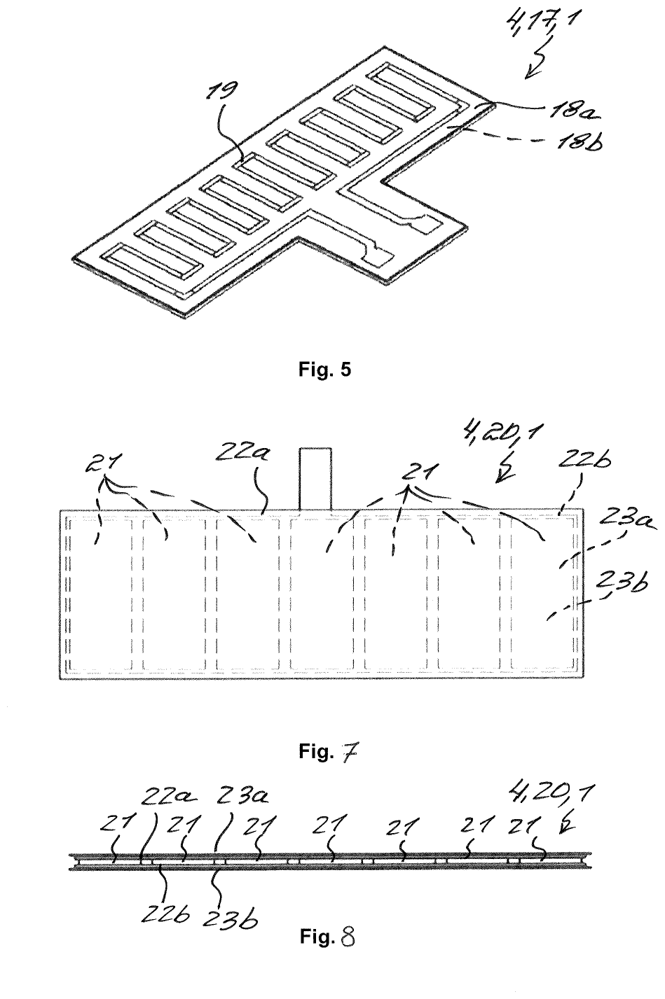

The high-voltage heater 1 is provided for heating a coolant. In the process, the coolant flows via the coolant inlet 8a into the box 7a and then into the flat tubes 3. From the flat tubes 3, the coolant flows into the box 7b and via the coolant outlet 8b out of the box 7b. When flowing through the flat tubes 3, the coolant is heated by means of the heating elements 4 that are connected to the flat tubes 3 in a heat-transferring manner. In the following, the construction of the heating elements 4 is explained in more detail by way of FIG. 5 to FIG. 9.

For controlling the heating elements 4, the high-voltage heater 1 comprises a circuit board 9 with multiple semi-conductor elements 10. The circuit board 9 is attached in the high-voltage heater 1 by means of a holding frame 11. The attachment of the circuit board 9 and of the holding frame 11 is explained in more detail in the following by way of FIG. 10 to FIG. 13. The circuit board 9 is electrically contacted with the two heating elements 4 by means of current conductor rails 12 and is electrically conductible towards the outside by means of a connector 13.

Further, the high-voltage heater 1 comprises a housing 14. The housing 14 can be formed out of aluminium for improving EMC or out of plastic. The housing 14 is arranged between the boxes 8a and 8b and firmly connected to the bottoms 5a and 5b in each case in a fluid-tight manner—for example by means of a ring seal. In this exemplary embodiment, the housing 14 is formed in two parts and comprises a housing part 14a and a housing part 14b. The housing parts 14a and 14b are screwed to one another and because of this firmly connected. Between the two housing parts 14a and 14b an elastic seal can be clamped, which seals the housing 14 towards the outside. Alternatively, the two housing halves 14a and 14b can be glued to one another and additionally screwed to one another.

FIG. 3 shows a view and FIG. 4 shows an exploded view of the stack 2 in the high-voltage heater 1 according to the invention. In this exemplary embodiment, the stack 2 is formed out of the three flat tubes 3 and out of the two heating elements 4. Here, the heating elements 4 are arranged between the flat tubes 3 and connected to the respective adjacent flat tubes 3 in a heat-transferring manner. The heating elements 4 can be printed onto one of the adjacent flat tubes 3 or crimped to the two adjacent flat tubes 3 in the stacking direction SR or glued to the two adjacent flat tubes 3 by means of a heat-conductive adhesive.

The respective flat tube 3 comprises two end regions 3a and 3b on the longitudinal end side adjacent to the bottoms 5a and 5b and a middle region 3c situated between the end regions 3a and 3b. The two flat tubes 3 situated on the outside in the stack each comprise an offset 15a and 15b in the end regions 3a and 3b. The middle flat tube 3 by contrast does not comprise an offset. Because of this, the respective adjacent flat tubes 3 are a greater distance apart in the end regions 3a and 3b than in the middle regions 3c. Because of this, the heating elements 4 can be arranged lying against the middle regions 3c in a heat-transferring manner and yet sufficient bottom material for connecting the flat tubes 3 to the bottoms 5a and 5b can be provided. Further, the cassetting of the flat tubes 3 can thus be simplified.

Further it is noticeable in FIG. 3 and in FIG. 4 that the flat tubes 3 comprise ribs 16 located inside. By way of the ribs 16 located inside, the coolant can be guided in the flat tubes 3 and because of this the heat exchange in the high-voltage heater 1 improved. The respective flat tube 3 can be an extruded profile or a welded tube.

FIG. 5 shows a view of the heating element 4 in the form of a TFR heating element 17. FIG. 6 shows a view of the TFR heating element 17 on the flat tube 3. Here and further, elements that are not directly visible are marked with interrupted lines. The TFR heating element 17 comprises a first dielectric insulation layer 18a, a resistance track 19 and a second dielectric insulation layer 18b. The insulation layers 18a and 18b can be single-layer or multi-layer. The resistance track 19 is arranged between the insulation layers 18a and 18b and because of this electrically insulated towards the outside and from the respective adjacent flat tubes 3. The TFR heating element 17 can be applied onto a substrate—for example printed on. In FIG. 6, the TFR heating element 17 is applied with the differently formed resistance track 19 onto the flat tube 3 and because of this connected to the flat tube 3 in a heat-transferring manner.

FIG. 7 shows a plan view of the heating element 4 in the form of a PTC heating element 20. FIG. 8 shows a lateral view of the PTC heating element 20. Here, the PTC heating element 20 comprises multiple PTC stones 21, two electrically conductive contact plates 22a and 22b and two dielectric insulating plates 23a and 23b. The PTC stones 21 are arranged between the contact plates 22a and 22b and the contact plates 22a and 22b with the PTC stones 21 are arranged between the insulating plates 23a and 23b. Because of this, the PTC heating element 20 is electrically insulated towards the outside and from the respective adjacent flat tubes 3. The PTC heating element 20 can be glued to the adjacent flat tubes 3 in a heat-transferring manner by means of a heat-conductive adhesive or crimped between the adjacent flat tubes 3.

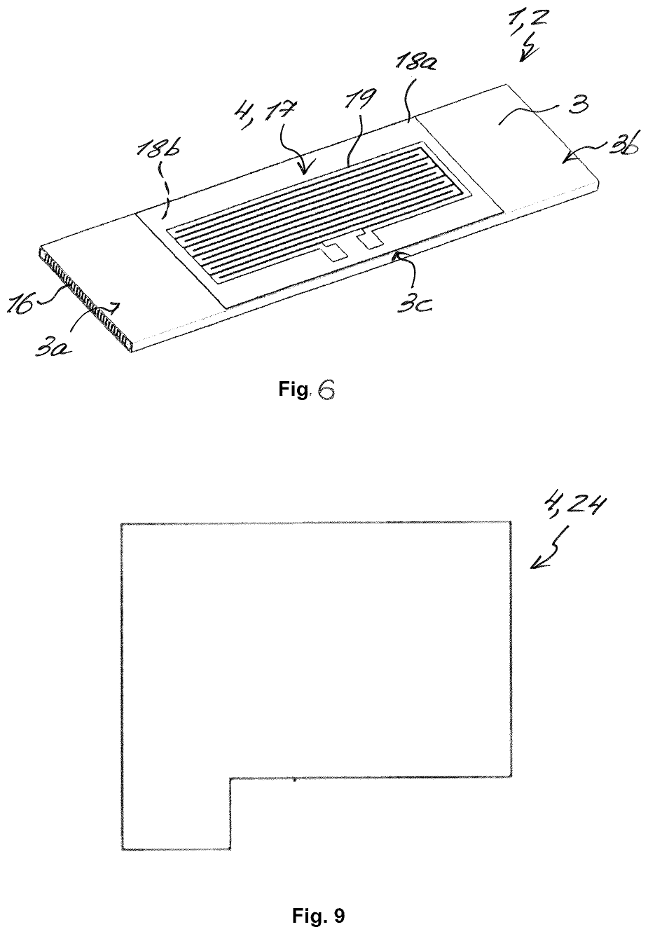

FIG. 9 shows a plan view of the heating element 4 in the form of a film heating element 24. The film heating element 24 comprises two insulation films, between which a resistance track is arranged. The film heating element 24 is thus electrically insulated by the insulation films towards the outside and from the respective adjacent flat tubes 3. The film heating element 24 can be glued to the at least one flat tube 3 in a heat-transferring manner for example by means of a heat-conductive adhesive or be crimped between the two adjacent flat tubes 3 in a heat-transferring manner.

FIG. 10 to FIG. 13 show views of the high-voltage heater 1 according to the invention each in a partly constructed state.

In FIG. 10, the stack 2 is fluidically connected to the two bottoms 5a and 5b. Further, the housing 14b of the housing 14 is firmly connected to the two bottoms 5a and 5b.

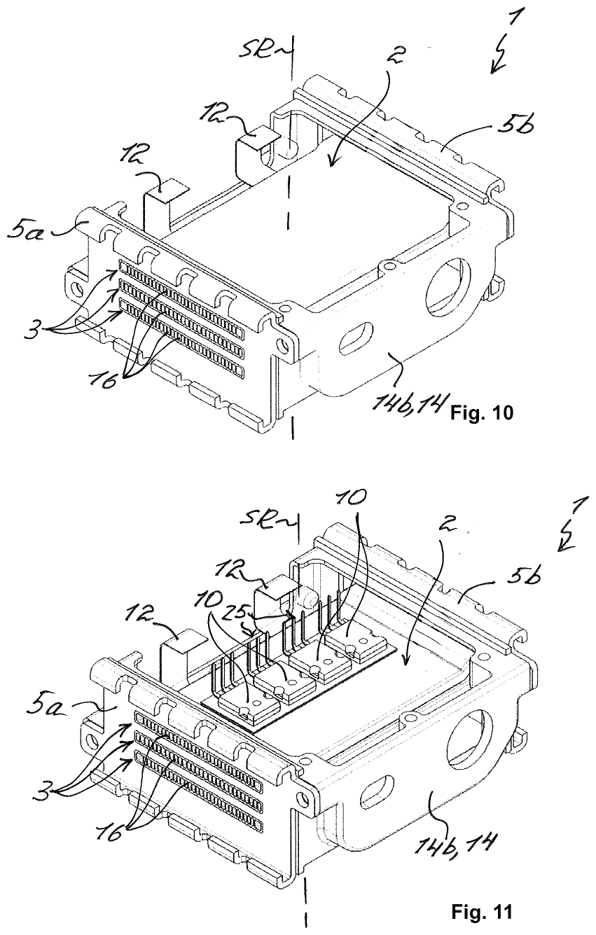

In FIG. 11, the semi-conductor elements 10 of the circuit board 9 are arranged on the flat tube 3 situated on the outside in a heat-transferring manner. The semi-conductor elements 10 can be glued to the flat tube 3 in a heat-transferring manner by means of a heat-conductive adhesive or be pressed against the flat tube 3 in a heat-transferring manner by means of the holding frame 11—see FIG. 13 in this regard. Because of this, the semi-conductor elements 10 can also be cooled by the coolant.

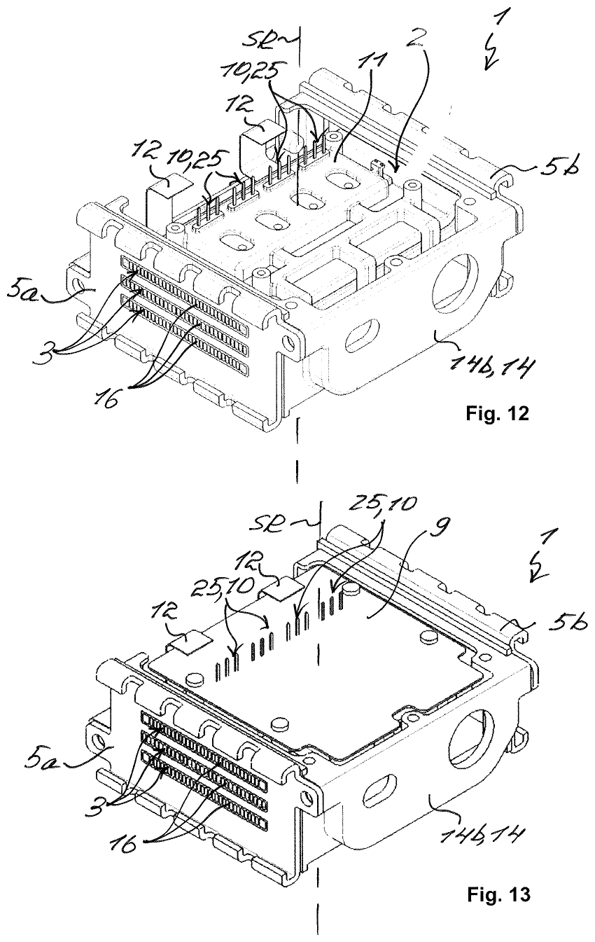

In FIG. 12, the holding frame 11 is arranged on the flat tube 3 situated on the outside and presses the semi-conductor elements 10 against the flat tube 3 in a heat-transferring manner. In the holding frame 11, legs 25 of the semi-conductor elements 10 are additionally guided, which simplifies the cassetting of the circuit board 9.

In FIG. 13, the circuit board 9 is now arranged on the holding frame 11 and screwed to the holding frame 11. The current conductor rails 12 connect the circuit board 9 with the two heating elements 4. When, here, the two lids 6a and 6b, the connectors 13 and the housing part 14a are attached, the high-voltage heater 1 according to FIG. 1 is obtained.

1. A high-voltage heater for a motor vehicle for heating a coolant, comprising:
at least two flat tubes that can be flowed through by the coolant and at least one heating element,
wherein the at least two flat tubes the at least one heating element are alternatingly stacked on top of one another in a stacking direction to form a stack, and
wherein the at least one heating element is connected at least to one of the adjacent flat tubes in the stack in a heat-transferring manner.

2. The high-voltage heater according to claim 1, further comprising:
two bottoms oriented transversely to the stacking direction and opposite to one another, and two lids oriented transversely to the stacking direction and opposite to one another,
wherein the two lids are connected to the two bottoms in a fluid-tight manner and each delimit a respective box towards the outside, and
at least two flat tubes fluidically lead through the two bottoms into the respective box and fluidically connect the respective boxes with one another.

3. The high-voltage heater according to claim 1, wherein:
the at least two flat tubes each comprise two end regions on a longitudinal end side and a middle region situated between the two end regions,
at least one of the at least two flat tubes comprises an offset at least on one of the two end regions, and
a distance of the at least one flat tube with the offset and another one of the at least two flat tubes that are adjacent in the stacking direction is greater in the two end regions via the offset than in the middle region.

4. The high-voltage heater according to claim 2, further comprising:
a housing arranged round about the stack,
the housing arranged transversely to the stacking direction between the two bottoms, and
the housing connected in a fluid-tight manner to the two bottoms each via an elastic ring seal or a bonding.

5. The high-voltage heater according to claim 2, wherein at least one of:
the two bottoms and the at least two flat tubes are integrally connected to one another,
the two lids are integrally connected to the two bottoms, and
the two lids are firmly connected to the two bottoms in a positive locking or non-positive locking manner, wherein between the two lids and the two bottoms each a seal is arranged and clamped in a sealing manner.

6. The high-voltage heater according to claim 1, further comprising:
a circuit board with at least one semi-conductor element,
the circuit board is contacted with the at least one semi-conductor element in an electrically conductive manner, and
the at least one semi-conductor element is connected to at least one of the at least two flat tubes in a heat-transferring manner.

7. The high-voltage heater according to claim 6, characterised further comprising:
a holding frame that carries the at least one semi-conductor element and the circuit board, and
the holding frame is firmly connected to at least one of a housing of the high-voltage heater and the stack of the high-voltage heater.

8. The high-voltage heater according to claim 1, wherein:
the at least one heating element is a PTC heating element,
the PTC heating element comprises at least one PTC stone, two electrically conductive contact plates and two dielectric insulating plates,
the at least one PTC stone is arranged between the two contact plates and contacted with the two contact plates in an electrically conductive manner, and
the two insulating plates are arranged on the two contact plates facing away from the at least one PTC stone.

9. The high-voltage heater according to claim 1, wherein:
the at least one heating element is a TFR heating element
the TFR heating element comprises a substrate, a single-layer or multi-layer first dielectric insulation layer, a resistance track and a single-layer or multi-layer second dielectric insulation layer, and
the first insulation layer is applied to the substrate, the resistance track to the first insulation layer and the second insulation layer to the resistance track.

10. The high-voltage heater according to claim 9, wherein the substrate of the TFR heating element is provided by at least one of the two flat tubes.

11. The high-voltage heater according to claim 1, wherein:
the at least one heating element is a film heating element,
the film heating element comprises a first dielectric insulation film, a resistance track and a second dielectric insulation film, and
the resistance track is arranged between the first insulation layer and the second insulation layer.

12. A motor vehicle, comprising: a high-voltage heater for heating a coolant, the high-voltage heating including:
at least two flat tubes flowable through by the coolant and at least one heating element;
the at least two flat tubes and the at least one heating element being alternately stacked on top of one another in a stacking direction to form a stack with the at least one heating element arranged between the at least two flat tubes; and
wherein the at least one heating element is connected to at least one of the two flat tubes in the stack in a heat-transferring manner.

13. The motor vehicle according to claim 12, wherein the high-voltage heater further includes two bottoms oriented transversely to the stacking direction and opposite to one another, and two lids oriented transversely to the stacking direction and opposite to one another;
the two lids connected to the two bottoms in a fluid-tight manner and each delimit a respective box towards the outside; and
the at least two flat tubes fluidically lead through the two bottoms into the respective box and fluidically connect the respective boxes with one another.

14. The motor vehicle according to claim 13, wherein:
the at least two flat tubes each comprise two end regions on a longitudinal end side and a middle region disposed between the two end regions;
at least one of the at leas two flat tubes comprises an offset on at least one of the two end regions; and
a distance of the at least one flat tube with the offset and another one of the at least two flat tubes is greater in the two end regions via the offset than in the middle region.

15. The motor vehicle according to claim 13, wherein the high-voltage heater further includes a housing arranged about the stack, the housing being arranged transversely to the stacking direction between the two bottoms, wherein the housing is connected in a fluid-tight manner to the two bottoms each via an elastic ring seal or a bonding.

16. The motor vehicle according to claim 13, wherein at least one of:
the two bottoms and the at least two flat tubes are connected to one another by a connection that is welded, laser-welded, soldered, or glued;
the two lids are connected to the two bottoms by a connection that is welded, laser-welded, soldered, or glued; and
the two lids are firmly connected to the two bottoms, wherein a seal is provided between the two lids and between the two bottoms.

17. The motor vehicle according to claim 12, wherein the high-voltage heater further includes a circuit board with at least one semi-conductor element;
the circuit board is contacted with the at least one semi-conductor element in an electrically conductive manner; and
the at least one semi-conductor element is connected to at least one of the at least two flat tubes in a heat-transferring manner.

18. The motor vehicle according to claim 17, wherein the high-voltage heater further includes a holding frame that carries the at least one semi-conductor element and the circuit board; and
wherein the holding frame is firmly connected to at least one of a housing of the high-voltage heater and the stack of the high-voltage heater.

19. The motor vehicle according to claim 12, wherein:
the at least one heating element is a PTC heating element;
the PTC heating element comprises at least one PTC stone, two electrically conductive contact plates, and two dielectric insulating plates;
the at least one PTC stone is arranged between the two contact plates and contacted with the two contact plates in an electrically conductive manner; and
the two insulating pates are arranged on the two contact plates facing away from the at least one PTC stone.

20. The motor vehicle according to claim 12, wherein:
the at least one heating element is a TFR heating element;
the TFR heating element comprises a substrate, a single-layer or multi-layer first dielectric insulation layer, a resistance track, and a single-layer or multi-layer second dielectric insulation layer; and
the first insulation layer is disposed on the substrate, the resistance track is disposed on the first insulation layer, and the second insulation layer is disposed on the resistance track.
